(19) United States
(12) Patent Application Publication
(10) Pub. No.: US 2006/0010166 A1
(43) Pub. Date: Jan. 12, 2006

(54) Production information managing system and method

(75) Inventors: Chin-Lin Lin, Tao Yuan Shien (TW); Huang-Yang Wu, Tao Yuan Shien (TW); Chih-Hao Chuang, Tao Yuan Shien (TW); Chia-Hsien Wang, Tao Yuan Shien (TW)

Correspondence Address: TROXELL LAW OFFICE PLLC, SUITE 1404, 5205 LEESBURG PIKE, FALLS CHURCH, VA, 22041, US

(73) Assignee: Quanta Computer Inc.

(21) Appl. No.: 11/168,481

(22) Filed: Jun. 29, 2005

(30) Foreign Application Priority Data
Jul. 12, 2004 (TW) 093120748

(51) Int. Cl. G06F 17/00

(52) U.S. Cl. 707/104.1

(57) ABSTRACT

The invention discloses a data processing system and method for managing production information associated with N1 electronic products requested according to a work order. N2 main devices are prepared based on the information of the work order and produced through a manufacturing line to produce N3 semi-products, and further through an assembling line to produce the N1 electronic products. Each of the main devices is provided with a respective first identification code at the start of the manufacturing line. Each of the semi-products is provided with a respective second identification code at the start of the assembling line. The system of the invention, based on the first identification code of each main device, records the operation information associated with said one main device produced through the equipments of the manufacturing line, and, based on the second identification code of each semi-product, records the operation information of said one semi-product produced through the equipments of the assembling line. The system and method of the invention further queries from the records and then displays the querying results.

### BACKGROUND OF THE INVENTION

1. Field of the Invention

The invention relates to a production information managing system and method thereof. More particularly, the invention provides different identification codes for each of the main devices and the semi-products, which are used for producing the electronic products, at the start of each producing stage. Moreover, based on the identification codes associated with each producing stage, the invention records the operation information of the main device and the semi-product in each producing stage, such that the operation information can be queried and displayed on-line.

2. Description of the Prior Art

Over the years, manufacturing processes have become more automated. Where repeated procedures are required, such as welding, machining or riveting, the use of automation has enhanced productivity and improved quality control by greatly reducing human error in the manufacturing process. However, in many cases, manual control is often necessary to initiate and/or terminate a process or to change out tooling and/or equipment.

Standardization of repeat operations is a primary feature of automation, though automation of manufacturing processes may take many forms and can be done at almost any phase of the process, from fabrication to inspection and packaging of a completed product. In true automation, the process or step being automated involves a sensing system for making decisions about the device or process and then a control system that reacts to the sensed information and provides control reaction. Several prior arts, for example, describe intelligent tools for assembly and machining through the use of sensing devices. The tools provide information with regard to part location, machining, detail location, and automation.

Manufacturing systems are also becoming more integrated. Workers involved in the manufacturing process, by controlling and operating the machinery on the shop floor, are gaining greater efficiencies through “smarter” shop floor control systems.

Still, new processes are needed to further reduce errors during assembly and provide greater efficiencies through the use of smart systems.

### SUMMARY OF THE INVENTION

Accordingly, an objective of the invention is to provide a production information managing system and method thereof. More particularly, according to the production information managing system and method thereof, the invention records the operation information of whole producing line, such that the operation information can be referred to and displayed on-line, so as to increase the producing efficiency.

Accordingly, another objective of the invention is to provide a production information managing system and method thereof. More particularly, according to the production information managing system and method thereof, the invention provides different identification codes to each of the main devices and the semi-products, which are used for producing the electronic products, at the start of each producing stage, and then based on the identification codes associated with each producing stage, the invention records the operation information of the main device and the semi-product in each producing stage, such that the operation information can be queried and displayed on-line.

Accordingly, another objective of the invention is to provide a production information managing system and method thereof. More particularly, according to the production information managing system and method thereof, the invention incorporates the identification codes used for external control with the internal production information managing system and controls the producing line with economic benefits.

According to a preferred embodiment of the invention, a data processing system manages production information associated with N1 electronic products requested according to a work order. N2 main devices are prepared based on the information of the work order and produced through a manufacturing line to produce N3 semi-products, and further through an assembling line to produce the N1 electronic products. Each of the main devices is provided with a respective first identification code at the start of the manufacturing line. Each of the semi-products is provided with a respective second identification code at the start of the assembling line. The manufacturing line and the assembling line both include a plurality of workstations. Each of the workstations includes at least one equipment for implementing a respective operation charged by said one workstation. Furthermore, each of the workstations includes at least one computer communicating with the system and collecting operation information associated with the corresponding equipment(s). In the above, N1 is a natural number, N3 is an integer equal to or larger than N1, and N2 is an integer equal to or larger than N3. According to a preferred embodiment of the invention, the data processing system includes a first recording module, a second recording module, a first querying module, a second querying module, and a displaying module. The first recording module, based on the first identification code of each main device, is used for recording the operation information associated with said one main device produced through the equipments of the manufacturing line. The second recording module, based on the second identification code of each semi-product, is used for recording the operation information of said one semi-product produced through the equipments of the assembling line. The first querying module, according to at least one first criterion, is used for querying from the record of the first recording module. The second querying module, according to at least one second criterion, is used for querying from the record of the second recording module. The displaying module is used for displaying the querying results of the first querying module and the second querying module.

The advantage and spirit of the invention may be understood by the following recitations together with the appended drawings.

### BRIEF DESCRIPTION OF THE APPENDED DRAWINGS

FIG. 1A through FIG. 1C are schematic diagrams illustrating a production line utilizing the production information managing system according to the invention.

FIG. 2 is a schematic diagram illustrating the production information managing system according to a preferred embodiment of the invention.

FIG. 3A and FIG. 3B respectively show an example displayed by the displaying module according to the production information managing system of the invention.

FIG. 4 is a flowchart of the production information managing method according to a preferred embodiment of the invention.

### DETAILED DESCRIPTION OF THE INVENTION

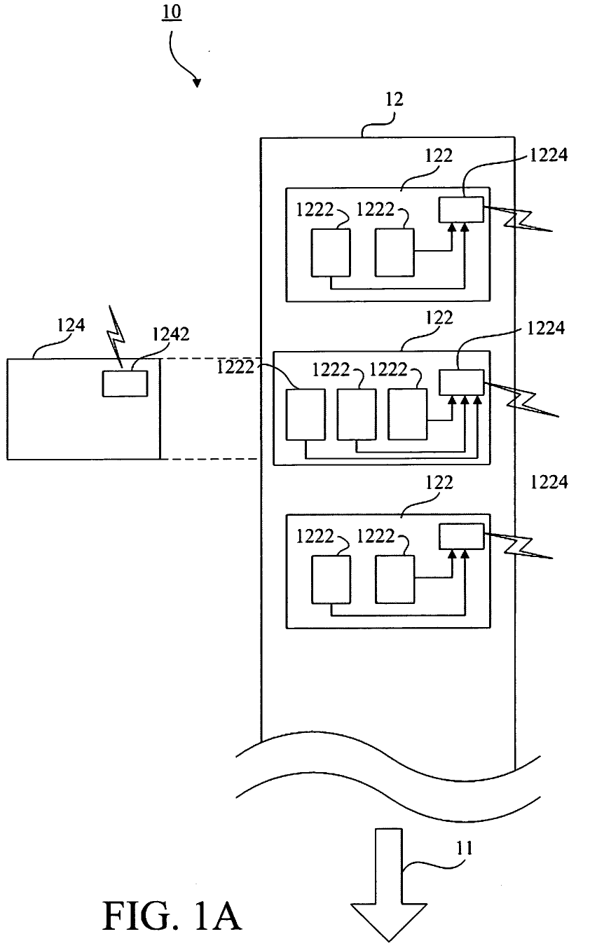

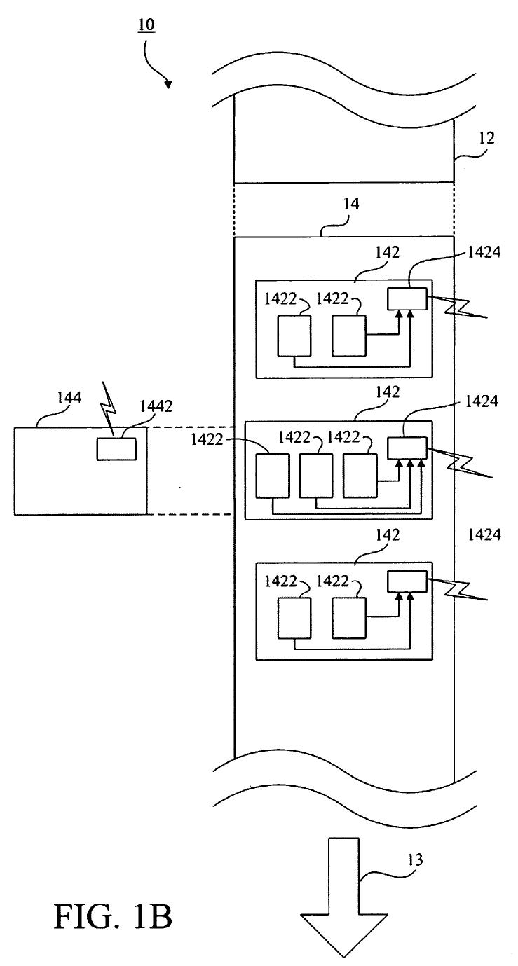

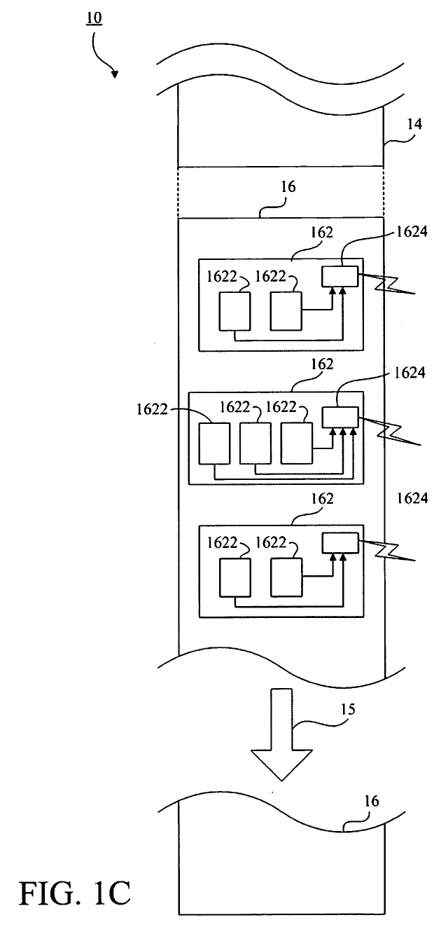

Referring to FIG. 1A through FIG. 1C, FIG. 1A through FIG. 1C are schematic diagrams illustrating a producing line 10 utilizing the production information managing system according to the invention. As shown in FIGS. 1A through 1C, the producing line 10 includes a manufacturing line 12, an assembling line 14, and a packing line 16.

As shown in FIG. 1A, the manufacturing line 12 includes a plurality of workstations 122. Each of the workstations 122 includes at least one equipment 1222 for implementing a respective operation charged by said one workstation 122. Furthermore, each of the workstations 122 includes at least one computer 1224 communicating with the production information managing system and collecting operation information associated with the corresponding equipment(s) 1222.

Before each batch of products is produced, the materials have to be pre-manufactured according to the production information of the work order. If the work order requests N1 electronic products to be produced, the production manager will manufacture N2 main devices beforehand based on the information of the work order, the experience, the wastage, the yield rate, and so on. According to the invention, each of the main devices is provided with a respective first identification code at the start of the manufacturing line 12. Each of the main devices is processed through the equipment 1222 of the manufacturing line 12 and along the direction of the arrow 11 shown in FIG. 1A. When the main device passes through all of the workstations 122 of the manufacturing line 12, the semi-product would be produced. In general, the main devices would have wastage during the producing process, that is to say, N2 main devices can only produce less than N2 semi-products. In the following, N3 semi-products are produced when N2 main devices are processed through the manufacturing line 12, wherein N1 is a natural number, N3 is an integer equal to or larger than N1, and N2 is an integer equal to or larger than N3. Afterward, the accomplished semi-products are sent to the assembling line 14 to be assembled.

As shown in FIG. 1B, the assembling line 14 includes a plurality of workstations 142. Each of the workstations 142 includes at least one equipment 1422 for implementing a respective operation charged by said one workstation 142. Furthermore, each of the workstations 142 includes at least one computer 1424 communicating with the production information managing system and collecting operation information associated with the corresponding equipment(s) 1422.

According to the invention, each of the semi-products is provided with a respective second identification code at the start of the assembling line 14. Each of the semi-products is processed through the equipment 1422 of the assembling line 14 and along the direction of the arrow 13 shown in FIG. 1B. When the semi-product passes through all of the workstations 142 of the assembling line 14, the electronic product would be produced. In general, the semi-products would have wastage during the assembling process, that is to say, N3 semi-products can only produce less than N3 electronic products. Afterward, the accomplished electronic products are sent to the packing line 16 to be packed.

As shown in FIG. 1C, the packing line 16 includes a plurality of workstations 162. Each of the workstations 162 includes at least one equipment 1622 for implementing a respective operation charged by said one workstation 162. Furthermore, each of the workstations 162 includes at least one computer 1624 communicating with the production information managing system and collecting operation information associated with the corresponding equipment(s) 1622.

Referring to FIG. 1A again, at least one first repairing shop 124 is further set up in the manufacturing line 12. Each of the first repairing shops 124 corresponds to at least one of the workstations 122 of the manufacturing line 12. When a main device on a workstation 122 of the manufacturing line 12 fails to be operated, the main device will be sent to the first repairing shop 124 corresponding to the workstation 122 for reparation. When the main device is repaired completely, it will be sent back to the original workstation 122, so as to proceed with the follow-up operations. If the main device cannot be repaired, the system will determine that the operation of the main device is failed. Each of the first repairing shops 124 includes at least one computer 1242 communicating with the production information managing system and collecting operation information associated with the first repairing shop 124.

Referring to FIG. 1B again, at least one second repairing shop 144 is further set up in the assembling line 14. Each of the second repairing shops 144 corresponds to at least one of the workstations 142 of the assembling line 14. When a semi-product on a workstation 142 of the assembling line 14 fails to be operated, the semi-product will be sent to the second repairing shop 144 corresponding to the workstation 142 for reparation. When the semi-product is repaired completely, it will be sent back to the original workstation 142, so as to proceed with the follow-up operations. If the semi-product cannot be repaired, the system will determine that the operation of the semi-product is failed. Each of the second repairing shops 144 includes at least one computer 1442 communicating with the production information managing system and collecting operation information associated with the second repairing shop 144.

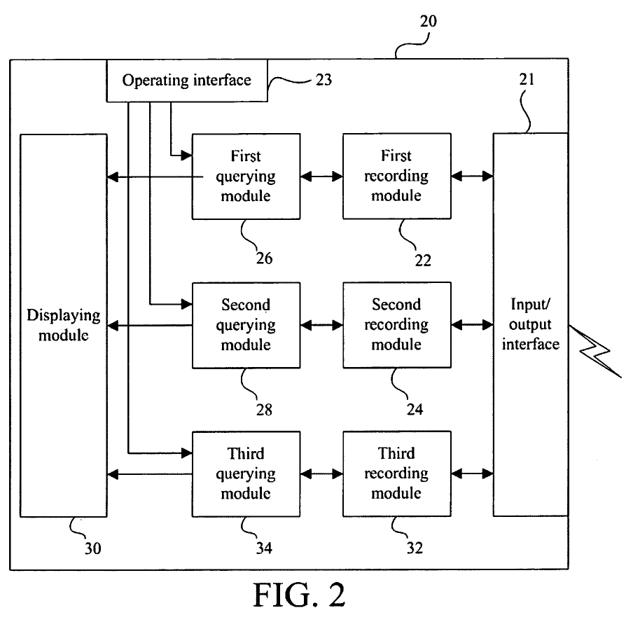

Referring to FIG. 2, FIG. 2 is a schematic diagram illustrating the production information managing system 20 according to a preferred embodiment of the invention. As shown in FIG. 2, the production information managing system 20 includes a first recording module 22, a second recording module 24, a first querying module 26, a second querying module 28, and a displaying module 30. The production information managing system 20 further includes an input/output interface 21 for respectively communicating with the computer 1224 of the manufacturing line 12, the computer 1242 of the first repairing shop 124, the computer 1424 of the assembling line 14, and the computer 1442 of the second repairing shop 144.

The first recording module 22, via the input/output interface 21 and based on the first identification code of each main device, is used for recording the operation information associated with the main device produced through the equipments 1222 of the manufacturing line 12. In other words, the first identification code of each main device is the primary key when the first recording module 22 records the operation information. Accordingly, the location of a specific main device on the manufacturing line 12 can be traced on-line by the first identification code corresponding to the location.

In an embodiment, N2 main devices are circuit boards, and all kinds of electronic components are soldered onto the circuit boards through the manufacturing line 12.

The second recording module 24, via the input/output interface 21 and based on the second identification code of each semi-product, is used for recording the operation information associated with the semi-product produced through the equipments 1422 of the assembling line 14. In other words, the second identification code of each semi-product is the primary key when the second recording module 24 records the operation information. Accordingly, the location of a specific semi-product on the assembling line 14 can be traced on-line by the second identification code corresponding to the location.

The first querying module 26, according to at least one first criterion, is used for querying from the record of the first recording module 22. The second querying module 28, according to at least one second criterion, is used for querying from the record of the second recording module 24. The displaying module 30 is used for displaying the querying results of the first querying module 26 and the second querying module 28. In an embodiment, the displaying module 30 transforms the querying results of the first querying module 26 and the second querying module 28 into a graphic user interface and then displays the querying results.

In an embodiment, based on the at least one first criterion, the first querying module 26 can query the status of the manufacturing line 12. The first criterion can be a quantity of the main devices to be operated between two of the workstations 122 of the manufacturing line 12, a ratio of the main devices operated successfully and the main devices been operated by one of the workstations 122 and the equipments 1222 of the manufacturing line 12, a ratio of the main devices first operated successfully and the main devices been operated by one of the workstations 122 and the equipments 1222 of the manufacturing line 12, and a quantity of the main devices operated unsuccessfully by one of the workstations 122 and the equipments 1222 of the manufacturing line 12. Accordingly, the status of whole or partial manufacturing line 12 can be queried on-line in accordance with the demand. As shown in FIG. 2, the production information managing system 20 of the invention further includes an operating interface 23. The production manager can input the requested criterion to the first querying module 26 via the operating interface 23.

For example, when the production manager wants to query the yield rate of a specific workstation 122 of the manufacturing line 12 during a specific span of time, the first criterion represents the ratio of the main devices operated successfully to the main devices been operated by the specific workstation 122 during the specific span of time. According to the above-mentioned first criterion, the first querying module 26 queries the first recording module 22, and then the displaying module 30 displays the querying results of the first querying module 26 for the production manager.

In an embodiment, based on the at least one second criterion, the second querying module 28 can query the status of the assembling line 14. The second criterion can be a quantity of the semi-products to be operated between two of the workstations 142 of the assembling line 14, a ratio of the semi-products operated successfully and the semi-products been operated by one of the workstations 142 and the equipments 1422 of the assembling line 14, a ratio of the semi-products first operated successfully and the semi-products been operated by one of the workstations 142 and the equipments 1422 of the assembling line 14, and a quantity of the semi-products operated unsuccessfully by one of the workstations 142 and the equipments 1422 of the assembling line 14. Accordingly, the status of whole or partial assembling line 14 can be queried on-line in accordance with the demand. The production manager can input the requested criterion to the second querying module 28 via the operating interface 23.

For example, when the production manager wants to query the yield rate of a specific workstation 142 of the assembling line 14 during a specific span of time, the second criterion represents the ratio of the semi-products operated successfully to the semi-products been operated by the specific workstation 142 during the specific span of time. According to the above-mentioned second criterion, the second querying module 28 queries the second recording module 24, and then the displaying module 30 displays the querying results of the second querying module 28 for the production manager.

In another preferred embodiment, the first recording module 22, based on the first identification code of each main device, also records the operation information, if any, associated with the main device repaired by one of the first repairing shop(s) 124. In an embodiment, the first criterion can be a quantity of the main devices been repaired by one of the first repairing shop(s) 124, and a ratio of the main devices repaired successfully and the main devices been repaired by one of the first repairing shop(s) 124.

For example, when a user wants to query the repair rate of a specific first repairing shop 124 of the manufacturing line 12 during a specific span of time, the first criterion represents the ratio of the main devices repaired successfully to the main devices been repaired by the specific first repairing shop 124 during the specific span of time. According to the above-mentioned first criterion, the first querying module 26 queries the first recording module 22, and then the displaying module 30 displays the querying results of the first querying module 26 for the production manager.

In another preferred embodiment, the second recording module 24, based on the second identification code of each semi-product, also records the operation information, if any, associated with the semi-product repaired by one of the second repairing shop(s) 144. In an embodiment, the second criterion can be a quantity of the semi-products been repaired by one of the second repairing shop(s) 144, and a ratio of the semi-products repaired successfully and the semi-products been repaired by one of the second repairing shop(s) 144.

For example, when a user wants to query the repair rate of a specific second repairing shop 144 of the assembling line 14 during a specific span of time, the second criterion represents the ratio of the semi-products repaired successfully to the semi-products been repaired by the specific second repairing shop 144 during the specific span of time. According to the above-mentioned second criterion, the second querying module 28 queries the second recording module 24, and then the displaying module 30 displays the querying results of the second querying module 28 for the production manager.

In another preferred embodiment, the N1 electronic products are, based on the information of the work order, further produced by the packing line 16. According to the invention, each of the electronic products is provided with a respective third identification code at the start of the packing line 16. As shown in FIG. 2, the production information managing system 20 of the invention further includes a third recording module 32 and a third querying module 34. The third recording module 32, based on the third identification code of each electronic product, is used for recording the operation information associated with the electronic products produced through the equipments 1622 of the packing line 16. Accordingly, the location of a specific electronic product on the packing line 16 can be traced on-line by the third identification code corresponding to the location. The third querying module 34, according to at least one third criterion, is used for querying from the record of the third recording module 32. The displaying module 30 also displays the querying results of the third querying module 62. In an embodiment, the N1 electronic products are all wireless communication apparatus, such as cellular phone, personal digital assistant (PDA), etc. The third identification code is a unique international mobile equipment identity (IMEI) code. Accordingly, the third identification code can be taken as the identification code for external control, and even the cost of IMEI can be merged with the internal production information managing system 20 for control with economic benefits.

In an embodiment, based on the at least one third criterion, the third querying module 34 can query the status of the packing line 16. The third criterion can be a quantity of the electronic products to be operated between two of the workstations 162 of the packing line 16, a ratio of the electronic products operated successfully and the electronic products been operated by one of the workstations 162 and the equipments 1622 of the packing line 16, a ratio of the electronic products first operated successfully and the electronic products been operated by one of the workstations 1625 and the equipments 1622 of the packing line 16, and a quantity of the electronic products operated unsuccessfully by one of the workstations 162 and the equipments 1622 of the packing line 16. Accordingly, the status of whole or partial packing line 16 can be queried on-line in accordance with the demand. The production manager can input the requested criterion to the third querying module 34 via the operating interface 23.

For example, when the production manager wants to query the yield rate of a specific workstation 162 of the packing line 16 during a specific span of time, the third criterion will represent the ratio of the electronic products operated successfully to the electronic products been operated by the specific workstation 162 during the specific span of time. According to the above-mentioned third criterion, the third querying module 34 queries the third recording module 32, and then the displaying module 30 displays the querying results of the third querying module 34 for the production manager.

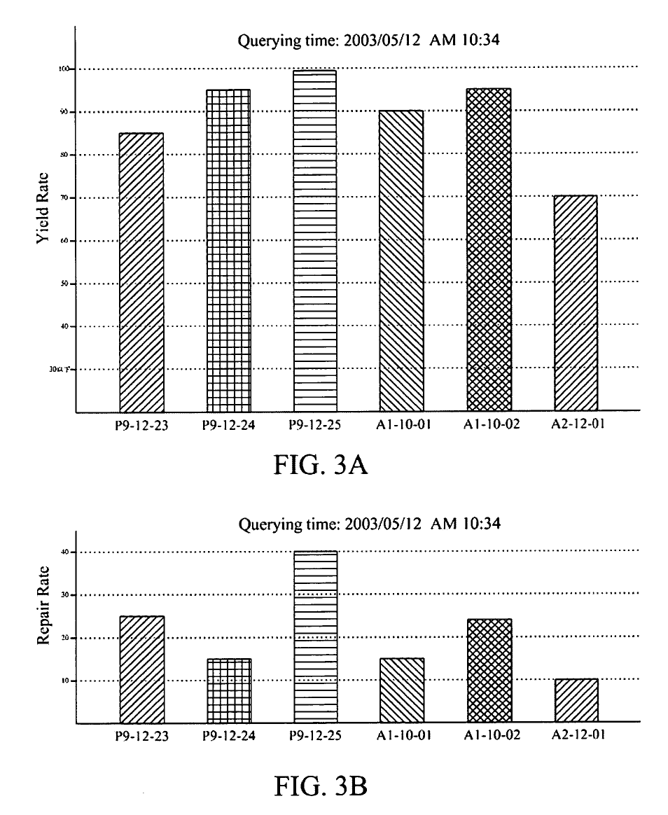

Referring to FIG. 3A and FIG. 3B, FIG. 3A and FIG. 3B respectively show an example displayed by the displaying module 30 according to the production information managing system 10 of the invention. According to the production information managing system 10 of the invention mentioned in the above, the requested criterion can be inputted by the production manager via the operating interface 23, the results recorded in the recording module can be queried by the corresponding querying module, and the querying results can be displayed by the displaying module 30. The diagram shown in FIG. 3A shows the yield rate of six workstations (taking the workstations on the manufacturing line as an example) requested by the production manager. The diagram shown in FIG. 3B shows the repair rate of each first repair shop corresponding to each of the workstations. The production manager can determine the current status of the manufacturing line on-line according to the displayed querying results. For example, when the yield rate of a specific workstation is lower than before, the production manager can overhaul the equipments corresponding to the specific workstation to eliminate the breakdown as soon as possible. The production manager can also query the specific workstation step by step to determine whether there is an error when preparing materials, the specific workstation is out of order, or a specific equipment has a breakdown.

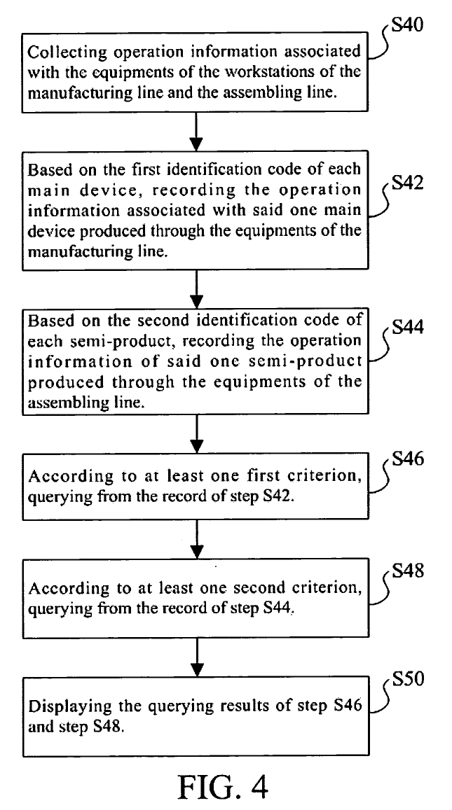

Referring to FIG. 4, FIG. 4 is a flowchart of the production information managing method according to a preferred embodiment of the invention. The application of the invention can be the producing line 10 including the manufacturing line 12 and the assembling line 14, as shown in FIG. 1A and FIG. 1B. Each of the main devices is provided with a respective first identification code at the start of the manufacturing line 12. Each of the semi-products is provided with a respective second identification code at the start of the assembling line 14. The production information managing method includes the following steps:

Step S40: Successively collect operation information associated with the equipments (1222, 1422) of the workstations (122, 142) of the manufacturing line 12 and the assembling line 14.

Step S42: Based on the first identification code of each main device, record the operation information associated with said one main device produced through the equipments 1222 of the manufacturing line 12.

Step S44: Based on the second identification code of each semi-product, record the operation information of said one semi-product produced through the equipments 1444 of the assembling line 14.

Step S46: According to at least one first criterion, query from the record of step S42.

Step S48: According to at least one second criterion, query from the record of step S44.

Step S50: Display the querying results of step S46 and step S48.

The preferred embodiment of the first criterion and the second criterion is mentioned in the above, and the related description is neglected.

In another preferred embodiment, both step S40 and step S42 are performed as the following:

Step S40: Successively collecting operation information associated with at least one first repairing shop 124.

Step S42: Based on the first identification code of each main device, record the operation information, if any, associated with the main device repaired by one of the first repairing shop(s) 124.

In another preferred embodiment, both step S40 and step S42 are performed as the following:

Step S40: Successively collecting operation information associated with at least one second repairing shop 144.

Step S42: Based on the second identification code of each semi-product, record the operation information, if any, associated with the semi-product repaired by one of the second repairing shop(s) 144.

In another preferred embodiment, the N1 electronic products, based on the information of the work order, are further produced via the packing line 16, as shown in FIG. 1C. According to the invention, each of the electronic products is provided with a respective third identification code at the start of the packing line 16. In step S40, the operation information associated with the equipments 1622 of the workstation 162 of the packing line 16 is also collected. In this embodiment, there is an additional step being performed except the steps shown in FIG. 4. Based on the third identification code of each electronic product, the operation information of the electronic product produced through the equipments 1622 of the packing line 16 is recorded. Afterward, according to at least one third criterion, the record of preceding one step is queried, and then the querying results are displayed. The preferred embodiment of the third criterion is mentioned in the above, and the related description is neglected.

In accordance with the detailed description of the invention mentioned in the above, the characteristics and the advantages of the invention are summarized as the following:
(a) The invention can collect the information of whole producing line on-line, and the information can be queried and further displayed, so as to improve the producing rate of the producing line.
(b) The main devices and the semi-products, used for producing the electronic products, are provided with different identification codes at each start of the producing stages, and based on the identification codes associated with each producing stage, the system will record the operation information of the main devices and the semi-products in each producing stage for the production manager to query on line.
(c) The invention incorporates the identification code used for external control with the internal production information managing system and controls the producing line with economic benefits.
(d) The production manager can change the querying criterion based on the requirement, and the changed querying results can be displayed instantaneously.

With the example and explanations above, the features and spirits of the invention will be hopefully well described. Those skilled in the art will readily observe that numerous modifications and alterations of the device may be made while retaining the teaching of the invention. Accordingly, the above disclosure should be construed as limited only by the metes and bounds of the appended claims.

What is claimed is:

1. A data processing system for managing production information associated with N1 electronic products requested according to a work order, N2 main devices being prepared based on the information of the work order and produced through a manufacturing line to produce N3 semi-products, and further through an assembling line to produce the N1 electronic products, each of the main devices being provided with a respective first identification code at the start of the manufacturing line, each of the semi-products being provided with a respective second identification code at the start of the assembling line, the manufacturing line and the assembling line both comprising a plurality of workstations which each comprises at least one equipment for implementing a respective operation charged by said one workstation and at least one computer communicating with said system and collecting operation information associated with the corresponding equipment(s), said system comprising:
a first recording module, based on the first identification code of each main device, for recording the operation information associated with said one main device produced through the equipments of the manufacturing line;
a second recording module, based on the second identification code of each semi-product, for recording the operation information of said one semi-product produced through the equipments of the assembling line;
a first querying module, according to at least one first criterion, for querying from the record of the first recording module;
a second querying module, according to at least one second criterion, for querying from the record of the second recording module;
a displaying module for displaying the querying results of the first querying module and the second querying module; and
wherein N1 is a natural number, N3 is an integer equal to or larger than N1, and N2 is an integer equal to or larger than N3.

2. The system of claim 1, wherein the at least one first criterion comprises one selected from the group consisting of a quantity of the main devices to be operated between two of the workstations of the manufacturing line, a ratio of the main devices operated successfully and the main devices been operated by one of the workstations and the equipments of the manufacturing line, a ratio of the main devices first operated successfully and the main devices been operated by one of the workstations and the equipments of the manufacturing line, and a quantity of the main devices operated unsuccessfully by one of the workstations and the equipments of the manufacturing line.

3. The system of claim 1, at least one first repairing shop, which each corresponds to at least one of the workstations of the manufacturing line, being set up, each first repairing shop comprising a computer communicating with said system and collecting operation information associated with said one first repairing shop, and wherein the first recording module, based on the first identification code of each main device, also records the operation information, if any, associated with said one main device repaired by one of the first repairing shop(s).

4. The system of claim 3, wherein the at least one first criterion comprises one selected from the group consisting of a quantity of the main devices been repaired by one of the first repairing shop(s), and a ratio of the main devices repaired successfully and the main devices been repaired by one of the first repairing shop(s).

5. The system of claim 1, wherein the at least one second criterion comprises one selected from the group consisting of a quantity of the semi-products to be operated between two of the workstations of the assembling line, a ratio of the semi-products operated successfully and the semi-products been operated by one of the workstations and the equipments of the assembling line, a ratio of the semi-products first operated successfully and the semi-products been operated by one of the workstations and the equipments of the assembling line, and a quantity of the semi-products operated unsuccessfully by one of the workstations and the equipments of the assembling line.

6. The system of claim 1, at least one second repairing shop, which each corresponds to at least one of the workstations of the assembling line, being set up, each second repairing shop comprising a computer communicating with said system and collecting operation information associated with said one second repairing shop, and wherein the second recording module, based on the second identification code of each semi-product, also records the operation information, if any, associated with said one semi-product repaired by one of the second repairing shop(s).

7. The system of claim 6, wherein the at least one second criterion comprises one selected from the group consisting of a quantity of the semi-products been repaired by one of the second repairing shop(s), and a ratio of the semi-products repaired successfully and the semi-products been repaired by one of the second repairing shop(s).

8. The system of claim 1, wherein the main devices are circuit boards.

9. The system of claim 1, the N1 electronic products being, based on the information of the work order, further produced through a packing line comprising a plurality of workstations which each comprises at least one equipment for implementing a respective operation charged by said one workstation and at least one computer communicating with said system and collecting operation information associated with the corresponding equipment(s), each of the N1 electronic products being provided with a respective third identification code at the start of the packing line, said system further comprising:
a third recording module, based on the third identification code of each electronic product, for recording the operation information of said one electronic product produced through the equipments of the packing line;
a third querying module, according to at least one third criterion, for querying from the record of the third recording module; and
wherein the displaying module also displays the querying results of the third querying module.

10. The system of claim 9, wherein the at least one third criterion comprises one selected from the group consisting of a quantity of the electronic products to be operated between two of the workstations of the packing line, a ratio of the electronic products operated successfully and the electronic products been operated by one of the workstations and the equipments of the packing line, a ratio of the electronic products first operated successfully and the electronic products been operated by one of the workstations and the equipments of the packing line, and a quantity of the electronic products operated unsuccessfully by one of the workstations and the equipments of the packing line.

11. The system of claim 10, wherein the electronic products are wireless communication apparatus.

12. The system of claim 11, wherein each of the third identification codes is a unique international mobile equipment identity (IMEI) code, respectively.

13. A data processing method for managing production information associated with N1 electronic products requested according to a work order, N2 main devices being prepared based on the information of the work order and produced through a manufacturing line to produce N3 semi-products, and further through an assembling line to produce the N1 electronic products, each of the main devices being provided with a respective first identification code at the start of the manufacturing line, each of the semi-products being provided with a respective second identification code at the start of the assembling line, the manufacturing line and the assembling line both comprising a plurality of workstations which each comprises at least one equipment for implementing a respective operation charged by said one workstation, said method comprising the steps of:
(a) successively collecting operation information associated with the equipments of the workstations of the manufacturing line and the assembling line;
(b1) based on the first identification code of each main device, recording the operation information associated with said one main device produced through the equipments of the manufacturing line;
(b2) based on the second identification code of each semi-product, recording the operation information of said one semi-product produced through the equipments of the assembling line;
(c1) according to at least one first criterion, querying from the record of step (b1);
(c2) according to at least one second criterion, querying from the record of step (b2);
(d) displaying the querying results of step (c1) and step (c2); and
wherein N1 is a natural number, N3 is an integer equal to or larger than N1, and N2 is an integer equal to or larger than N3.

14. The method of claim 13, wherein the at least one first criterion comprises one selected from the group consisting of a quantity of the main devices to be operated between two of the workstations of the manufacturing line, a ratio of the main devices operated successfully and the main devices been operated by one of the workstations and the equipments of the manufacturing line, a ratio of the main devices first operated successfully and the main devices been operated by one of the workstations and the equipments of the manufacturing line, and a quantity of the main devices operated unsuccessfully by one of the workstations and the equipments of the manufacturing line.

15. The method of claim 13, at least one first repairing shop, which each corresponds to at least one of the workstations of the manufacturing line, being set up, and wherein step (a) is also to collect operation information associated with the at least one first repairing shop, and step (b1) is also, based on the first identification code of each main device, to record the operation information, if any, associated with said one main device repaired by one of the at least one first repairing shop.

16. The method of claim 15, wherein the at least one first criterion comprises one selected from the group consisting of a quantity of the main devices been repaired by one of the first repairing shop(s), and a ratio of the main devices repaired successfully and the main devices been repaired by one of the first repairing shop(s).

17. The method of claim 13, wherein the at least one second criterion comprises one selected from the group consisting of a quantity of the semi-products to be operated between two of the workstations of the assembling line, a ratio of the semi-products operated successfully and the semi-products been operated by one of the workstations and the equipments of the assembling line, a ratio of the semi-products first operated successfully and the semi-products been operated by one of the workstations and the equipments of the assembling line, and a quantity of the semi-products operated unsuccessfully by one of the workstations and the equipments of the assembling line.

18. The method of claim 13, at least one second repairing shop, which each corresponds to at least one of the workstations of the assembling line, being set up, and wherein step (a) is also to collect operation information associated with the second repairing shop(s), and step (b2) is also, based on the second identification code of each semi-product, to record the operation information, if any, associated with said one semi-product repaired by one of the second repairing shop(s).

19. The method of claim 18, wherein the at least one second criterion comprises one selected from the group consisting of a quantity of the semi-products been repaired by one of the second repairing shop(s), and a ratio of the semi-products repaired successfully and the semi-products been repaired by one of the second repairing shop(s).

20. The method of claim 13, wherein the main devices are circuit boards.

21. The method of claim 13, the N1 electronic products being, based on the information of the work order, further produced through a packing line comprising a plurality of workstations which each comprises at least one equipment for implementing a respective operation charged by said one workstation, and wherein step (a) is also to collect operation information associated with the equipments of the workstations of the packing line, each of the N1 electronic products being provided with a respective third identification code at the start of the packing line, said method further comprises the steps of:
(b3) based on the third identification code of each electronic product, recording the operation information of said one electronic product produced through the equipments of the packing line;
(c3) according to at least one third criterion, querying from the record of step (b3); and
wherein step (d) is also to display the querying results of step (c3).

22. The method of claim 21, wherein the at least one third criterion comprises one selected from the group consisting of a quantity of the electronic products to be operated between two of the workstations of the packing line, a ratio of the electronic products operated successfully and the electronic products been operated by one of the workstations and the equipments of the packing line, a ratio of the electronic products first operated successfully and the electronic products been operated by one of the workstations and the equipments of the packing line, and a quantity of the electronic products operated unsuccessfully by one of the workstations and the equipments of the packing line.

23. The method of claim 22, wherein the electronic products are wireless communication apparatus.

24. The method of claim 23, wherein each of the third identification code is a unique international mobile equipment identity (IMEI) code, respectively.
